(19) United States
(12) Patent Application Publication
(10) Pub. No.: US 2012/0103095 A1
(43) Pub. Date: May 3, 2012

(54) PIEZOELECTRIC VIBRATION TYPE YAW RATE SENSOR

(75) Inventors: Takeshi WADA, Tokyo (JP); Ken UNNO, Tokyo (JP)

(73) Assignee: TDK CORPORATION, TOKYO (JP)

(21) Appl. No.: 13/276,770

(22) Filed: Oct. 19, 2011

(30) Foreign Application Priority Data
Oct. 29, 2010 (JP) 2010-244517

(51) Int. Cl. G01P 15/09

(52) U.S. Cl. 73/514.34

(57) ABSTRACT

A piezoelectric vibration type yaw rate sensor including driving arms and detection arms. A detection sensitivity spectrum of the detection arms has a first peak with a first resonance frequency in a first detection vibration mode, in which the driving and detection arms vibrate in opposite phases, and a second peak with a second resonance frequency in a second detection vibration mode, in which the driving and detection arms vibrate in the same phase. A detection sensitivity at a frequency higher by Δf than one smaller resonance frequency of the first and second resonance frequency is larger than a detection sensitivity at a frequency lower by Δf than the one resonance frequency. A detection sensitivity at a frequency lower by Δf than other larger resonance frequency of the first and second resonance frequency is larger than a detection sensitivity at a frequency higher by Δf than the other resonance frequency.

### CROSS-REFERENCES TO RELATED APPLICATIONS

The present application claims priority to prior filed Japanese Patent Application No. 2010-244517, filed on Oct. 29, 2010, the entire contents of which are hereby incorporated by reference.

### BACKGROUND

1. Field of the Invention

The present invention relates to a yaw rate sensor having high sensitivity and an excellent noise reduction effect.

2. Description of Related Art

As a piezoelectric vibration device for detecting micro vibration, for example, a piezoelectric vibration type yaw rate sensor (gyro sensor) has been known which is being capable of detecting/measuring a rotation action (rotation angular velocity) in each direction by detecting, via piezoelectric elements, extremely weak vibrations and displacements caused due to a Coriolis force, which is generated when a vibrating mass is rotated. Further, in recent years, as a long-life and low-cost as well as small and light-weight piezoelectric vibration type yaw rate sensor, an H type yaw rate sensor comprising a sensor element having a plurality of vibration arms opposed to each other with a base member sandwiched therebetween has been proposed or put to practical use in which: one of the vibration arms (driving arms) are driven in a plane; and the vibration/displacement generated, in a direction perpendicular to the drive direction, by the Coriolis force is detected by the other of vibration arms (detection arms).

However, in the H type yaw rate sensor having an extremely small sensor element, the mass of the driving arm is small, and thus the Coriolis force, which is represented by F=2 mvΩ, is small, leading to reduced detection sensitivity. In addition, while the base, to which the vibration arms of the sensor element are connected, is fixed to the substantially center part of, e.g., a sensor package, it is extremely difficult for the connection part between the vibration arms and the base to be made long in terms of the structure for the downsizing of the H type yaw rate sensor. As a result, the rigidity of the connection part is excessively high, and thus it is difficult for the vibration/displacement of the driving arm due to the Coriolis force to be made sufficiently large, leading to further reduced sensitivity for detecting the Coriolis force. Further, manufacturing the H type yaw rate sensor having an extremely small sensor element requires especially high processing accuracy and precision as well as assembly accuracy and precision, and thus if the accuracies and precisions are insufficient, it becomes easy to generate noise due to undesired vibration (leakage vibration).

Meanwhile, for example, patent document 1 proposes an angular velocity sensor intended to reduce undesired vibration (leakage vibration) by providing a plurality of vibration modes. The angular velocity sensor includes a vibrator with an H type structure. The frequency in an inciting vibration mode (a fanning vibration mode; third vibration mode) in which all the arms of the vibrator vibrate in the same direction is set between the frequency in a detection mode in which driving arms and detection arms vibrate in opposite phases (first vibration mode with opposite right and left phases and opposite upper and lower phases) and the frequency in a detection mode in which driving arms and detection arms vibrate in the same phase (second vibration mode with opposite right and left phases and same upper and lower phases). The vibrator is excited at a frequency close to the frequency in the inciting vibration mode. As a result, the leakage vibration is concentrated in the inciting vibration mode, and also, the vibration in the thickness direction is a same phase (coordinate) vibration.
Patent document 1: Japanese Patent No. 3769322

### SUMMARY

However, the inciting vibration caused in the angular velocity sensor disclosed in patent document 1 is flexing vibration of the entire vibrator for hiding leakage vibration, and thus an same phase signal with extremely large amplitude (of vibration) is expected to be generated. The same phase signal with such large amplitude then becomes harmful noise for the detection of a Coriolis force, and therefore, it is extremely difficult to detect a detection signal based on an extremely weak Coriolis force.

In light of the above, in the conventional H type yaw rate sensor and the angular velocity sensor disclosed in patent document 1, it has been impossible to attain the sufficient improvement of sensitivity and reduction of noise, i.e., the sufficient improvement of an S/N ratio.

The present invention has been made in light of the above circumstances, and an object of the invention is to provide a piezoelectric vibration type yaw rate sensor having high sensitivity compared to the prior art and having an excellent noise reduction effect.

In order to solve the above problem, a piezoelectric vibration type yaw rate sensor according to the invention comprises: at least one pair of driving arms and at least one pair of detection arms, the at least one pair of detection arms detecting a Coriolis force generated in the at least one pair of driving arms, wherein a detection sensitivity spectrum of the at least one pair of detection arms has a first peak with, as a peak frequency, a first resonance frequency in a first detection vibration mode, in which the at least one pair of driving arms and the at least one pair of detection arms vibrate in opposite phases, and a second peak with, as a peak frequency, a second resonance frequency in a second detection vibration mode, in which the at least one pair of driving arms and the at least one pair of detection arms vibrate in the same phase, and wherein, in the detection sensitivity spectrum, a detection sensitivity at a frequency higher by Δf than one smaller resonance frequency in the first resonance frequency and the second resonance frequency is larger than a detection sensitivity at a frequency lower by Δf than the one resonance frequency, and a detection sensitivity at a frequency lower by Δf than other larger resonance frequency in the first resonance frequency and the second resonance frequency is larger than a detection sensitivity at a frequency higher by Δf than the other resonance frequency. In this case, the detection sensitivity spectrum is a total of a detection sensitivity spectrum in the first detection vibration mode and a detection sensitivity spectrum in the second detection vibration mode.

According to the above configuration, the first peak and the second peak, i.e., the resonance frequency in the first detection vibration mode and the resonance frequency in the second detection vibration mode are close to each other in the detection sensitivity spectrum of the piezoelectric vibration type yaw rate sensor. This leads to a vibration form in which the vibrations in the two modes reinforce each other, where the detection sensitivity spectrums are combined/totaled up. As a result, the amplitude in the detection arms is increased significantly, enabling the improvement in sensitivity of the sensor.

Further, in the piezoelectric vibration type yaw rate sensor according to the invention, a driving vibration resonance frequency of the driving arms may be set between the first resonance frequency in the first detection vibration mode (peak frequency of the first peak) and the second resonance frequency in the second detection vibration mode (peak frequency of the second peak).

According to the above configuration, when the first detection vibration mode and the second detection vibration mode are provided to coexist, this produces a vibration form in which the vibrations in the Z direction of the detection arms amplify each other while the vibrations in the Z direction of the driving arms cancel each other, leading to the reduction of the amplitude. This can significantly prevent undesired vibration (leakage vibration) in the driving arms from vibrating the detection arms in the case where rotation is not applied from the outside to the piezoelectric vibration type yaw rate sensor so that a Coriolis force is not generated (i.e., the state of the piezoelectric vibration type yaw rate sensor not being rotated), and further can dramatically improve the S/N ratio of the piezoelectric vibration type yaw rate sensor. Further, the first detection vibration mode and the second detection vibration mode coexist in the state where a balance is achieved between the vibrations in the two modes (balanced state), and therefore, the balanced state between the vibration modes is lost momentarily in the state where rotation is applied from the outside to the piezoelectric vibration type yaw rate sensor so that a Coriolis force is generated (i.e., the state of the piezoelectric vibration type yaw rate sensor being rotated), resulting in larger vibration, whereby a further improvement in sensitivity of the sensor is attained.

Further, it is preferable that the piezoelectric vibration type yaw rate sensor according to the invention comprises a base member that includes: a frame to which the at least one pair of driving arms and the at least one pair of detection arms are connected; a connection island part that is formed inside the frame; a plurality of bridge parts that extends in a direction parallel to an extending direction of the at least one pair of driving arms and/or the at least one pair of detection arms and is provided across the frame; and a plurality of auxiliary bridge parts that connects the connection island part and the plurality of bridge parts. More specifically, the at least one pair of driving arms and the at least one pair of detection arms may extend in directions opposed to each other (opposite directions). Further, the shape of the frame is not particularly limited, and may be, for example, a square shape. Furthermore, it is preferable that the plurality of bridge parts and the plurality of auxiliary bridge parts are provided to extend in directions that cross each other, in particular, directions perpendicular or substantially perpendicular to each other.

With the above configuration, the connection island part, which is formed inside the frame (in the internal space of the frame) in the base member, can be fixed to, for example, a sensor package. In this case, the base member itself can effectively be prevented from being twisted when the vibration displacement generated in the driving arms due to the Coriolis force propagates to the detection arms. As a result, the displacement at the roots of the detection arms can be increased, enabling a further improvement of the detection sensitivity.

Further, an angular velocity detection method according to the invention is a method implemented using a piezoelectric vibration type yaw rate sensor of the invention, i.e., a method of detecting an angular velocity of a piezoelectric vibration type yaw rate sensor by detecting, by at least one pair of detection arms in the piezoelectric vibration type yaw rate sensor, a Coriolis force generated in at least one pair of driving arms in the piezoelectric vibration type yaw rate sensor, the method comprising: configuring (forming) or controlling (adjusting) the piezoelectric vibration type yaw rate sensor such that a detection sensitivity spectrum of the at least one pair of detection arms has a first peak with, as a peak frequency, a first resonance frequency in a first detection vibration mode, in which the at least one pair of driving arms and the at least one pair of detection arms vibrate in opposite phases, and a second peak with, as a peak frequency, a second resonance frequency in a second detection vibration mode, in which the at least one pair of driving arms and the at least one pair of detection arms vibrate in the same phase, and such that in the detection sensitivity spectrum, a detection sensitivity at a frequency higher by Δf than one smaller resonance frequency of the first resonance frequency and the second resonance frequency is larger than a detection sensitivity at a frequency lower by Δf than the one resonance frequency, and a detection sensitivity at a frequency lower by Δf than other larger resonance frequency of the first resonance frequency and the second resonance frequency is larger than a detection sensitivity at a frequency higher by Δf than the other resonance frequency.

In this case, it is preferable that a driving vibration resonance frequency of the driving arms is set between the first resonance frequency in the first detection vibration mode and the second resonance frequency in the second detection vibration mode.

Note that, more specifically, the resonance frequency of the driving arms can be set to the above desired frequency by appropriately controlling shape parameters such as the material, thickness, width, length, interval, etc., of the driving arms and/or detection arms and the relative arm fixing part.

### BRIEF DESCRIPTION OF THE DRAWINGS

FIG. 1 is a perspective view illustrating the configuration of an H type yaw rate sensor according to a first embodiment of the invention.

FIG. 2 is a schematic view (front view) illustrating the operating principle of the H type yaw rate sensor according to the first embodiment of the invention.

FIG. 3 is a schematic view (top view) illustrating the operating state in an HS mode of the H type yaw rate sensor according to the first embodiment of the invention.

FIG. 4 is a schematic view (top view) illustrating the operating state in an HC mode of the H type yaw rate sensor according to the first embodiment of the invention.

FIG. 5 is a schematic view (top view) illustrating the operating state of detection arms in the case where the HS mode and the HC mode are close to each other in the H type yaw rate sensor according to the first embodiment of the invention.

FIG. 6 is a graph showing a detection sensitivity spectrum in the case where the HS mode and the HC mode are close to each other in the H type yaw rate sensor according to the first embodiment of the invention.

FIG. 7 is a diagram showing the relationship between the respective resonance frequencies of the HS mode and the HC mode and the drive frequency of driving arms in an H type yaw rate sensor according to a second embodiment of the invention.

FIG. 8 is a schematic view (top view) illustrating the operating state of the driving arms in the case where the resonance frequency of the driving arms is set at a frequency between the resonance frequency in the HS mode and the resonance frequency in the HC mode in the H type yaw rate sensor according to the second embodiment of the invention.

FIG. 9 is a graph showing X−Z displacement of the driving arms in the case where the resonance frequency in the HS mode, the resonance frequency in the HC mode and a driving vibration resonance frequency are set sequentially in the H type yaw rate sensor according to the second embodiment of the invention.

FIG. 10 is a graph showing X−Z displacement of the driving arms in the case where the resonance frequency in the HS mode, the driving vibration resonance frequency and the resonance frequency in the HC mode are set sequentially in the H type yaw rate sensor according to the second embodiment of the invention.

FIG. 11 is a graph showing X−Z displacement of the driving arms in the case where the driving vibration resonance frequency, the resonance frequency in the HS mode and the resonance frequency in the HC mode are set sequentially in the H type yaw rate sensor according to the second embodiment of the invention.

FIG. 12 is a graph showing the relationship between the resonance frequency in the HS mode, the resonance frequency in the HC mode and the thickness of an element in an H type yaw rate sensor according to a third embodiment of the invention.

FIG. 13 is a perspective view illustrating the configuration of a conventional H type yaw rate sensor (element).

FIG. 14 is a graph showing a detection sensitivity spectrum in the conventional H type yaw rate sensor (element).

### DETAILED DESCRIPTION OF PREFERRED EMBODIMENTS

Embodiments of the invention will be described below with reference to the attached drawings. In the drawings, the same components are given the same reference numerals, and any repetitive description will be omitted. The positional relationship, such as top and bottom, left and right, etc., is as shown in the drawings unless otherwise specified. The dimensional ratios are not limited to those shown in the drawings. The below embodiments are just examples for describing the invention, and the invention is not limited to those embodiments. The invention can be modified in various ways without departing from the gist of the invention.

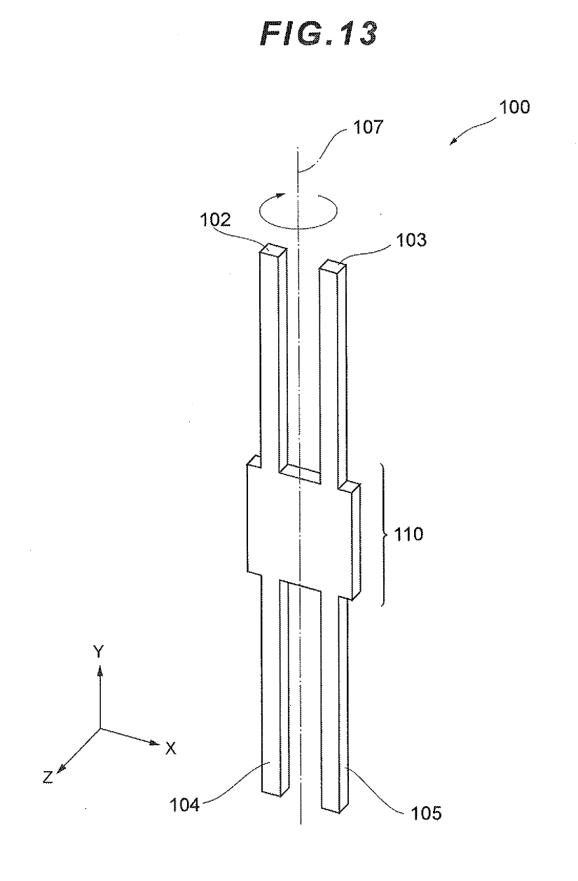

Here, a conventional H type yaw rate sensor will be described first to facilitate understanding the invention. FIG. 13 is a perspective view illustrating a conventional H type yaw rate sensor element 100. The H type yaw rate sensor element 100 includes a centrally positioned base member 110, a pair of driving arms 102 and 103 that extend in a predetermined direction (+Y direction in FIG. 13) to interpose the base member 100 therebetween, and a pair of detection arms 104 and 105 that extend in the opposite direction with respect to the driving arms 102 and 103 (−Y direction in FIG. 13). The H type yaw rate sensor element 100 is fixed, at a substantially center part of the base member 110, to a center package (not shown), and is held in an internal space of the center package and also provides an input/output of an electric signal with respect to piezoelectric elements (not shown).

In FIG. 13, the holding direction of the H type yaw rate sensor element 100 is selected such that the longitudinal direction of the H type yaw rate sensor element 100 matches the direction of a rotation center axis 107 serving as a subject of detection. Note that the H type yaw rate sensor element 100, which is constituted by the base member 110, the driving arms 102 and 103 and the detection arms 104 and 105, comprises a common material (e.g., silicon or crystal), and can be formed integrally or collectively through general wafer (silicon wafer, etc.) patterning processing (MEMS processing). Further, as the piezoelectric element, one formed by a piezoelectric material such as PZT can be given.

In general, a piezoelectric vibration type yaw rate sensor is operated in a driving vibration mode in which driving arms are driven (excited) initially (X-direction vibration in FIG. 13) and a detection vibration mode which is perpendicular to the direction of the driving vibration and which detects an angular velocity by detection arms (Z-axis direction vibration in FIG. 13). Further, in the H type yaw rate sensor element 100 comprising the opposing pairs of vibration arms (driving arms and detection arms) with the base member 110 sandwiched therebetween, at least two detection vibration modes exist in which the two detection arms 104 and 105 vibrate in opposite phases in the Z direction (these two detection vibration modes will be described in detail below).

In the conventional H type yaw rate sensor, a detection vibration mode has arbitrarily been selected when detecting a Coriolis force. However, it has been feared that the resonance frequencies of different vibration modes being close to each other causes the vibration shape of a detection vibration mode to suffer interference from the vibration shape of a vibration mode not selected for the detection of vibration, and it has been considered that the respective vibration shapes of the vibration modes are combined, resulting in the loss of an ideal detection vibration shape. Therefore, when a plurality of detection vibration modes coexist in the conventional H type yaw rate sensor, the sensor element has always been designed such that the resonance frequencies of the modes are not close to each other, and has not been designed actively such that the resonance frequencies of the detection vibration modes are close to each other.

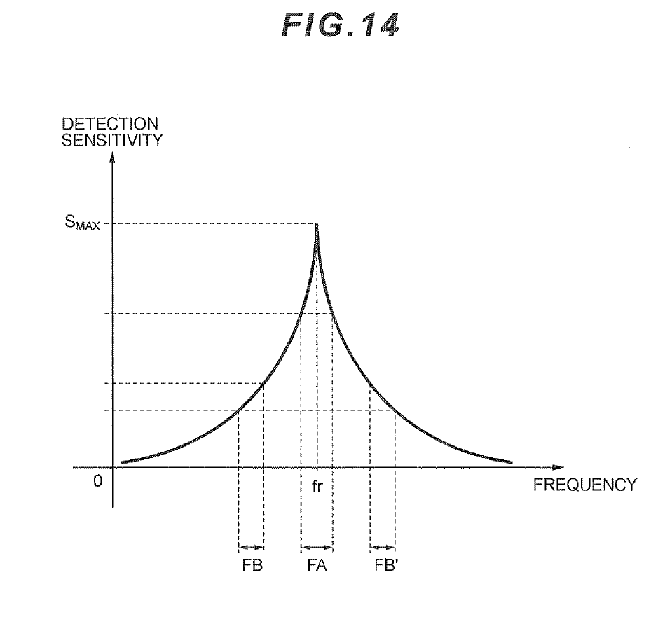

FIG. 14 shows a vibration spectrum (detection sensitivity spectrum) showing the relationship between a frequency F (X-axis direction) of detected vibration and sensitivity S (Y-axis direction) of detected vibration in the detection arms in the conventional H type sensor. As described above, the vibration spectrum used here derives from a detection vibration mode selected from among a plurality of vibration modes. FIG. 14 shows that, assuming that the value of the resonance frequency of vibration detected in the detection arms is fᵣ, the sensitivity of the H type yaw rate sensor at the frequency fᵣ indicates the maximum value, sensitivity S_{MAX}.

It has been confirmed based on experience that, when the driving arms are driven at a frequency close to the resonance frequency in the detection vibration mode selected for the detection of a Coriolis force, this leads to a configuration in which both the driving arms and the detection arms easily vibrate with respect to the driving vibration, which enables a larger detection signal to be obtained, resulting in an improvement in sensitivity of the sensor itself. That is, it may be considered that, when the resonance frequency of detected vibration and the resonance frequency of driving vibration are made close to each other, and further the driving arms are activated at a frequency close to the resonance frequencies, the sensitivity of the sensor is maximized. Here, referring to FIG. 14, when the resonance frequency of driving vibration is made to match a frequency area (region) FA (in the vicinity of the peak of the vibration spectrum in FIG. 14) close to the resonance frequency fᵣ in the detection vibration mode selected for the vibration arms in order to attain high vibration-detection sensitivity, the change of the detection sensitivity relative to the frequency change in the frequency area FA becomes extremely steep. Meanwhile, when the frequency of driving vibration is made to match a frequency area FB or FB′ (in the vicinity of the foot of the vibration spectrum in FIG. 14) which shows a gentle change of sensitivity and is away from the resonance frequency fr, the change of detection sensitivity is small, but the value of the sensitivity itself becomes low.

As a result, regarding the H type yaw rate sensor being an extremely small piezoelectric vibration type yaw rate sensor, it is difficult to keep the assembly precision at a high level, and it is difficult to have the driving vibration frequency (resonance frequency of the driving arms) fall within the frequency area FA in order to attain high detection sensitivity. In addition, when a slight variation in driving frequency occurs between manufactured sensors, this produces a large variation in detection sensitivity between the sensors, which is not preferable in terms of the sensor's performance. Further, it is not preferable in terms of the sensor's performance that the driving frequency (resonance frequency of the driving arms) is set to be within the frequency area FB having a gentle change in sensitivity in order to suppress a variation in sensitivity between the sensors, since this leads to the reduction of sensitivity.

### First Embodiment

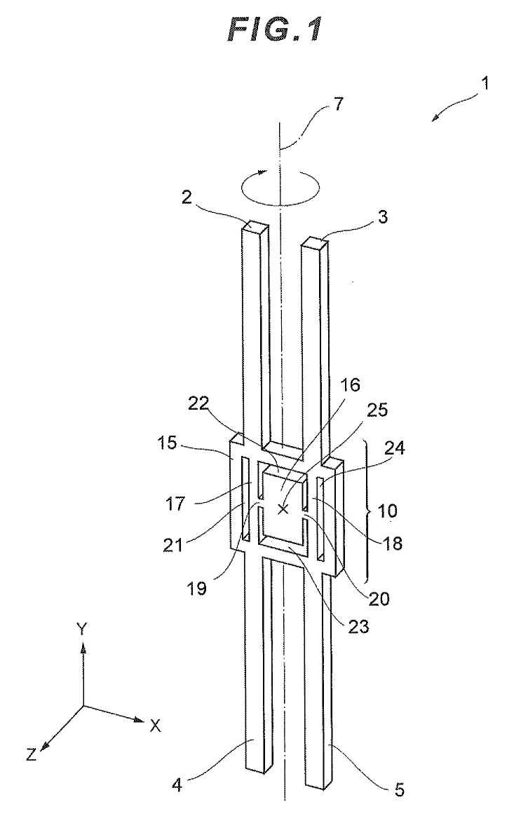

FIG. 1 is a perspective view illustrating an example of the configuration of an H type yaw rate sensor element 1 according to the present invention. The H type yaw rate sensor element 1 (piezoelectric vibration device) includes a centrally positioned base member 10, a pair of driving arms 2 and 3 that extend in a direction (+Y direction in FIG. 1) to interpose the base member 10 therebetween and a pair of detection arms 4 and 5 that extend in the opposite direction with respect to the driving arms 2 and 3 (−Y direction in FIG. 1).

The base member 10 of the H type yaw rate sensor element 1 in this embodiment has, at the center part of the internal space of a frame 15, to which the driving arms 2 and 3 and the detection arms 4 and 5 are connected, a connection island part 16 for connecting the H type yaw rate sensor element 1 to a sensor package (not shown). The connection island part 16 includes two bridge parts 17 and 18 that run in parallel in the Y direction in the internal space of the frame 15 as well as auxiliary bridge parts 19 and 20 that run in series in the X direction to hold the connection island part 16 between the bridge parts 17 and 18. Here, the left bridge part 17 is provided substantially in series with the extending direction of the left driving arm 2 and the left detection arm 4, and the right bridge part 18 is provided substantially in series with the extending direction of the right driving arm 3 and the right detection arm 5. The base member 10 has been subjected to lightening to provide cutouts 21 to 24 in order to define the above connection structure in the internal space of the frame 15.

The H type yaw rate sensor element 1 is fixed in the vicinity of a center part 25 of the connection island part 16 of the base member 10 with respect to the sensor package so as to be held in the internal space of the package, and also is electrically connected to an integrated circuit (not shown) in the sensor package through wire bonding, etc., so as to transmit driving signals to a plurality of piezoelectric elements (not shown) provided to the driving arms 2 and 3 of the H type yaw rate sensor element 1 and to electrically receive detection signals output from a plurality of piezoelectric elements provided to the detection arms 4 and 5. Note that the H type yaw rate sensor element 1, which is constituted by the base member 10, the driving arms 2 and 3 and the detection arms 4 and 5, comprises a common material (e.g., silicon or crystal), and can be formed integrally or collectively through general wafer (silicon wafer, etc.) patterning processing (MEMS processing). Further, the piezoelectric elements may be formed by a piezoelectric material (not shown) such as PZT.

The H type yaw rate sensor element 1 in this embodiment has the lightened base member 10, and is connected to the sensor package only via the connection island part 16 held in the internal space of the base member 10, and therefore, this can effectively prevent the entire base member 10 from being twisted when Z-direction vibration displacement generated, due to a Coriolis force, in the driving arms 2 and 3 propagates through the detection arms 4 and 5. Preventing twisting of the base member 10 enables larger displacement at the roots of the detection arms 4 and 5 (connecting parts between the detection arms 4 and 5 and the frame 15), and thus the detection sensitivity of the H type yaw rate sensor element 1 can be improved. Further, the bridge parts 17 and 18 not only hold the connection island part 16 but also respectively connect the driving arms 2 and 3 and the detection arms 4 and 5 substantially in series, whereby the Z-direction displacement, due to the Coriolis force, generated in the driving arms 2 and 3 can be transmitted efficiently to the detection arms 4 and 5 while the frame 15 ensures the rigidity of the base member 10 itself. Meanwhile, the auxiliary bridge parts 19 and 20 hold the connection island part 16 laterally (in the direction perpendicular to the extending direction of the bridge parts 17 and 18), and therefore, vibration resulting from the Z-direction displacement due to the Coriolis force is hard to propagate through the connection island part 16.

Next, the operating principle of the H type yaw rate sensor element 1 in this embodiment will be described. In this embodiment, the H type yaw rate sensor element 1 is held, in the sensor package, in an upright posture with the driving arms 2 and 3 located above and the detection arms 4 and 5 located below such that the longitudinal direction of the H type yaw rate sensor element 1 matches the direction of the center axis 7 of the rotation serving as a subject of detection. When a driving voltage is applied to the piezoelectric elements (not shown) provided to the driving arms 2 and 3 via the electrical connection in the base member 10, driving vibration occurs in the driving arms 2 and 3 due to stretching motion of the piezoelectric materials. Specifically, vibrational motion occurs in which the driving arms 2 and 3 repeatedly move closer to/away from each another in the ±X direction in FIG. 1.

When rotation occurs around the center axis 7 in the longitudinal direction (Y direction) of the H type yaw rate sensor element 1 in the above vibration state of the driving arms 2 and 3, the angular velocity of the rotation represented by the Coriolis force formula: F=2 mvΩ acts, as a Coriolis force, on the H type yaw rate sensor element 1 so that a Z-direction Coriolis force perpendicular to both the direction of driving vibration (X direction) and the rotation axis (Y direction) is generated in the driving arms 2 and 3. The Coriolis force appears as Z-direction amplitude (displacement) proportional to the size of the rotation angular velocity. In the H type yaw rate sensor element 1 in this embodiment, the resonance frequency of the detection arms 4 and 5 is set to be close to the resonance frequency (driving frequency) of the driving arms 2 and 3. Thus, the Z-direction vibration generated in the driving arms 2 and 3 propagates through the base member 10 toward the detection arms 4 and 5, and detection vibration then occurs in the detection arms 4 and 5. The piezoelectric elements detect the vibration displacement in the detection arms 4 and 5, which has transmitted, thereby detecting the angular velocity of the rotation motion generated in the H type yaw rate sensor element 1.

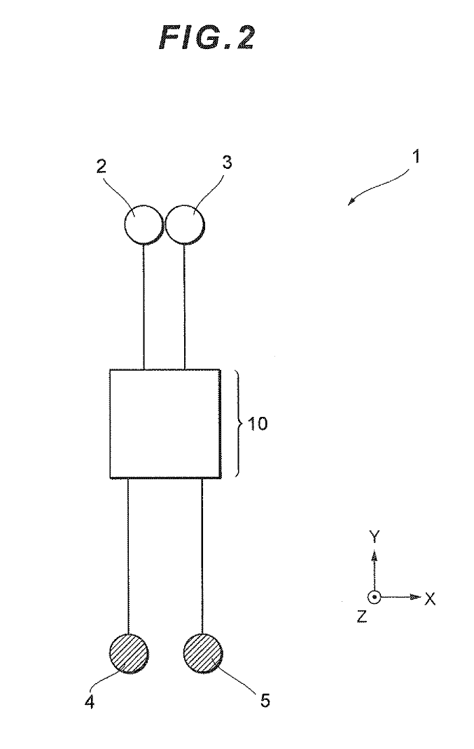

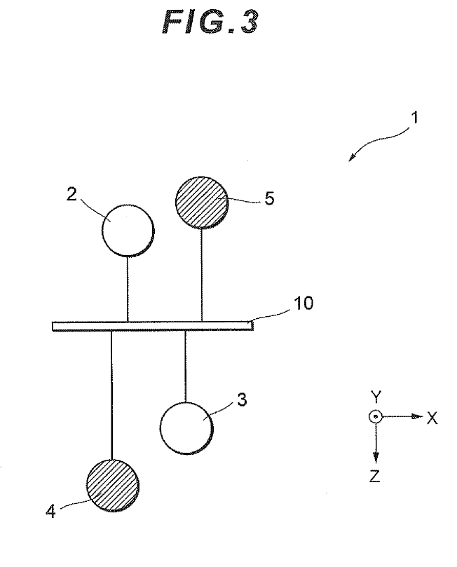

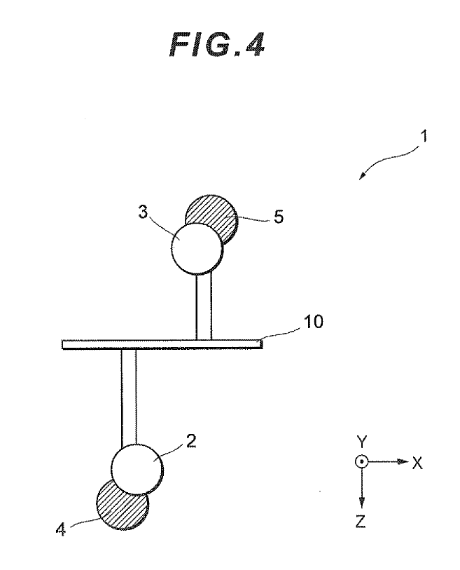

FIGS. 2 to 4 are schematic views illustrating the operating principles of the H type yaw rate sensor element 1 according to this embodiment. FIG. 2 is a schematic front view of the H type yaw rate sensor element 1. FIGS. 3 and 4 are schematic top views of the H type yaw rate sensor element 1 in which the H type yaw rate sensor element 1, operated in a first vibration mode and a second vibration mode respectively, is seen from above (+Y direction).

As described above, the H type yaw rate sensor element 1, which includes the pairs of vibration arms (driving arms 2 and 3 and detection arms 4 and 5) opposed to each other with the base member 10 sandwiched therebetween, comprises at least two detection vibration mode in which the two detection arms 4 and 5 vibrate in opposite phases in the Z direction. The detection vibration modes, in which the two detection arms 4 and 5 vibrate in opposite phases in the Z direction, are divided into the two modes: a vibration mode in which the driving arms 2 and 3 and the detection arms 4 and 5 vibrate in opposite phases in the Z direction (first vibration mode with opposite right and left phases and opposite upper and lower phase: HS mode) and a vibration mode in which the driving arms 2 and 3 and the detection arms 4 and 5 vibrate in the same phases in the Z direction (second vibration mode with opposite right and left phases and same upper and lower phases: HC mode). Detection vibration that has propagated from the driving arms 2 and 3 through the base member 10 may be generated in the detection arms 4 and 5 both in the HS mode in FIG. 3 and the HC mode in FIG. 4. The H type yaw rate sensor element 1 according to this embodiment is characterized by designing the sensor such that the resonance frequencies of the two modes are close to each other.

As shown in FIGS. 3 and 4, the HS mode and the HC mode differ in that the left and right driving arms 2 and 3 vibrate in opposite phases in the Z direction, but focusing attention only on the motion of the detection arms 4 and 5, the HS mode and the HC mode provide the same action. Here, which one of the left and right arms 2 and 3 starts its vibration from a +position or −position, i.e., the direction of vibration with respect to phases can easily be determined by incorporating asymmetry, etc., of the structure of the driving arms 2 and 3 into the element design. Therefore, if the resonance frequencies are close to each other, both the vibration shapes do not become deformed, and instead, the vibrations interfere with each other to increase the relevant amplitude (the sensitivities in the two modes can be totaled up).

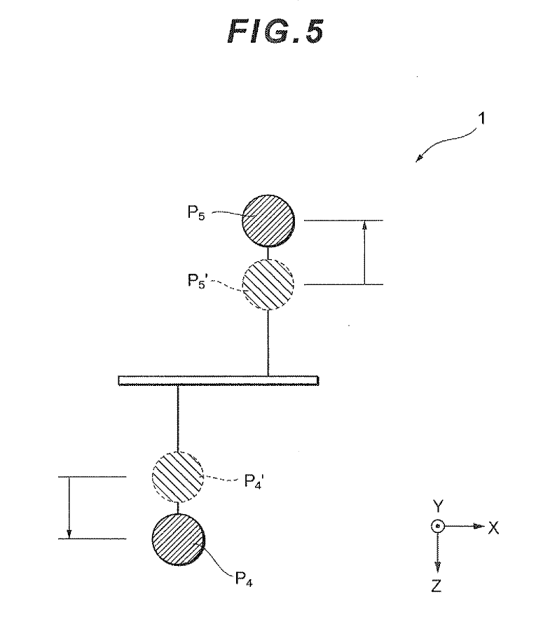

FIG. 5 is a top view in which the H type yaw rate sensor element 1 is seen from above (+Y direction), which schematically shows the change in amplitude (sensitivity change) of the detection arms 4 and 5 in the case where the HS mode and the HC mode coexist. In this case, the detection arms 4 and 5, i.e., the left and right detection arms vibrate in the same direction with respect to the Z direction in the vibration detection modes, the HS mode and the HC mode. More specifically, assuming that the left detection arm 4 starts to vibrate in the +Z direction in the HS mode, the right detection arm 5 starts to vibrate in the −Z direction. At this point, the HC mode presents the same behavior, which means that the left detection arm 4 starts to vibrate in the +Z direction while the right detection arm 5 starts to vibrate in the −Z direction. That is, the detection arms 4 and 5 take a vibration form in which the vibrations in the Z direction reinforce each other, resulting in a larger amplitude in which both the amplitudes are totaled up.

Accordingly, as shown in FIG. 5, when the HS mode and the HC mode coexist, regarding the left detection arm 4, the amplitude will be increased from an amplitude position P₄,′ which would be reached in the HS mode only, to an amplitude position P₄, which is obtained by further adding, in the +Z direction, an amplitude to the amplitude position P₄. Regarding the right detection arm 5 as well, the amplitude will be increased from an amplitude position P₅,′ which would be reached in the HS mode only, to an amplitude position P₅, which is obtained by further adding, in the −Z direction, an amplitude to the amplitude position P₅. That is, in the case where the HS mode and the HC mode coexist, the detection arms 4 and 5 take a vibration form in which the vibrations in the Z direction reinforce each other, and as a result, the amplitude in the detection arms 4 and 5 is increased, leading to the improvement in sensitivity of the H type yaw rate sensor element 1.

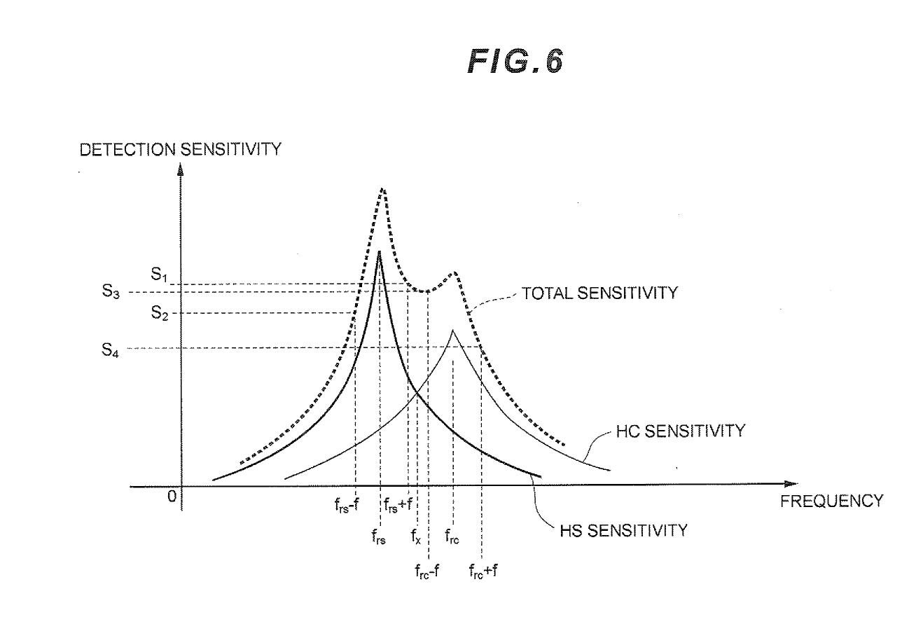

FIG. 6 shows a vibration spectrum showing the relationship between a frequency F (X-axis direction) and sensitivity S (Y-axis direction) of detection vibration in each of the vibration modes of the detection arms 4 and 5 in the H type yaw rate sensor element 1 according to this embodiment. The detection vibration modes shown in FIG. 6 are two modes, an HS mode and an HC mode, and the detection sensitivity spectrums of the modes are indicated by solid lines. In this embodiment, a resonance frequency fᵣₛ of the HS mode is closer to lower frequency than a resonance frequency f_{rc} of the HC mode, but the relationship may be inverted. Further, the sensitivity in the HS mode is higher than the sensitivity in the HC mode on the whole, but this relationship may also be inverted. Moreover, indicated by the broken lines in FIG. 6 is a total detection sensitivity spectrum of the detection arms 4 and 5 in the state where the HS mode and the HC mode are combined.

In this embodiment, the resonance frequency fᵣₛ of the HS mode and the resonance frequency f_{rc} of the HC mode are close to each other compared to the case of a conventional H type yaw rate sensor in which the coexistence of the two modes is avoided. The degree of closeness of the resonance frequencies depends on the shapes of the detection sensitivity spectrums of the modes which are determined by an arbitrary parameter such as the material, thickness, etc., of the H type yaw rate sensor element 1; however, the degree requires that the detection sensitivities of the modes can be totaled advantageously, and excludes the case where the two modes overlap at the foots of the spectrums of the mode which show low detection sensitivities. More specifically, in this embodiment, it is preferable that the spectrums of the two modes overlap such that a total detection sensitivity S₁ at a frequency fᵣₛ+f, which has been shifted to the high frequency side, by an arbitrary frequency f, from the resonance frequency fᵣₛ corresponding to the peak frequency in the HS mode, which indicates the peak with a lower frequency band, is larger than a total detection sensitivity S₂ at a frequency fᵣₛ−f, which has been shifted to the low frequency side, by the frequency f, from the resonance frequency fᵣₛ and such that a total detection sensitivity S₃ at a frequency f_{rc}−f, which has been shifted to the low frequency side, by the frequency f, from the resonance frequency f_{rc} corresponding to the peak frequency in the HC mode, which indicates the peak with a higher frequency band, is larger than a total detection sensitivity S₄ at a frequency f_{rc}+f, which has been shifted to the high frequency side, by the frequency f, from the resonance frequency f_{rc}. As described above, the sensitivity totaling effect can further be improved by having the peaks of the resonance frequencies close to each other to cause the vibration spectrums of the two modes overlap each other.

As shown in FIG. 6, the effect of totaling the sensitivities of the detection sensitivity spectrums of the modes is higher in a frequency area closer to the resonance frequency in each mode. Therefore, in the H type yaw rate sensor element 1 according to this embodiment, the above sensitivity totaling effect can be obtained only by the resonance frequency of the driving arms 2 and 3 being close to either of the respective resonance frequencies of the HS mode and the HC mode. Note that the resonance frequency, etc., of each mode can be set by fine-tuning various conditions such as the material and thickness of the sensor element, the shape of the base member, the shape of the vibration arm, etc.

### Second Embodiment

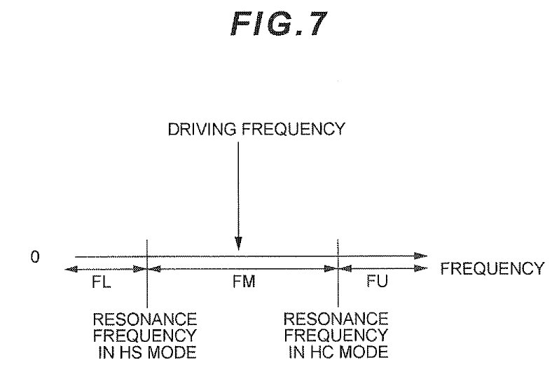

This embodiment will describe in detail an H type yaw rate sensor with a high S/N ratio which attains increased sensitivity and the reduction of noise. Note that the H type yaw rate sensor element 1 according to the first embodiment and the yaw rate sensor according to this embodiment do not necessarily have a clear difference in outer appearance, and the vibration frequency in a driving mode can be set between the resonance frequencies of two detection modes by fine-tuning various conditions such as the material and thickness of the sensor element, the shape of the base member, the shape of the vibration arm, etc. FIG. 7, with the horizontal axis indicating frequency, shows the relationship between the driving frequency of the H type yaw rate sensor element 1 according to this embodiment and the resonance frequencies of the HS mode and the HC mode. Note that the resonance frequency in the HS mode is set lower than the resonance frequency in the HC mode in this embodiment as well; however the same effect can be obtained also in the case where the resonance frequency in the HS mode is higher than the resonance frequency in the HC mode depending on the above-mentioned various conditions of the configuration of the sensor element.

It is assumed in FIG. 7 that the frequency area lower than the resonance frequency in the HS mode is an FL area, the area between the resonance frequency in the HS mode and the resonance frequency in the HC mode is an FM area, and the area higher than the resonance frequency in the HC mode is an FU area.

Considering the behavior of the driving arms 2 and 3, in the FL area, the behavior of the driving arms in the HS mode is mainly dominant in which the left and right driving arms 2 and 3 are displaced in the direction opposite to that of the left and right detection arms 4 and 5, i.e., when the left detection arm 4 is displaced in the +Z direction, the left driving arm 2 is displaced in the −Z direction, while when the right detection arm 5 is displaced in the −Z direction, the right driving arm 3 is displaced in the +Z direction (see FIG. 3). Meanwhile, in the FU area, the behavior of the driving arm in the HC mode is mainly dominant in which the left and right driving arms 2 and 3 are displaced in the same direction as that of the left and right detection arms 4 and 5, i.e., when the left detection arm 4 is displaced in the +Z direction, the left driving arm 2 is also displaced in the +Z direction, while when the right detection arm 5 is displaced in the −Z direction, the right driving arm 3 is also displaced in the −Z direction (see FIG. 4).

On the other hand, in the FM area, the behaviors in the HS mode and the HC mode interfere with each other. Specifically, in the FM area, as the driving frequency is changed from the low frequency area (FL are) side to the high frequency area (FU area) side, the driving arms 2 and 3 attempt to vibrate in a direction opposite to the amplitude direction in the HS mode, and thus the vibration in the HS mode is gradually cancelled, i.e., subtracted, and as a result, the amplitude of the driving arms 2 and 3 in the HS mode is reduced. That is, the behavior of the driving arms 2 and 3 in the HS mode, which is dominant in the FL area, is gradually weakened; meanwhile, the behavior of the driving arms 2 and 3 in the HC mode becomes apparent, resulting in mixing of the behaviors in the two modes. When the driving frequency reaches a frequency fₓ (see FIG. 6) at the center part of the FM area, where the vibration spectrum of the HS mode crosses the vibration spectrum of the HC mode, the behaviors in the modes are combined substantially equally. If the driving frequency exceeds the crossover frequency fₓ, the driving arms 2 and 3 are brought into a mixed state where the behavior in the HC mode is dominant over the behavior in the HS mode. As the driving frequency is changed toward the FU area on the high frequency side, the behavior in the HC mode finally becomes dominant.

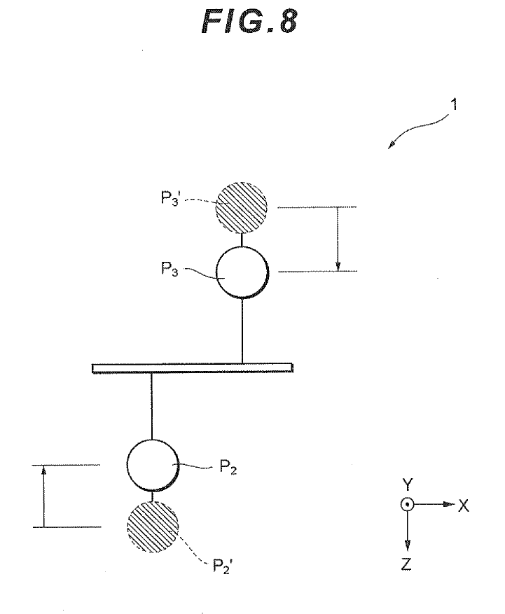

FIG. 8 is a top view in which the H type yaw rate sensor element 1 in this embodiment is seen from above (+Y direction), which schematically shows the effect of combining vibrations in the driving arms 2 and 3. FIG. 8 shows the amplitude change (sensitivity change) of the driving arms 2 and 3 of the H type yaw rate sensor element 1 in the case where: the HS mode and the HC mode coexist; and the driving frequency is set between the resonance frequency in the HS mode and the resonance frequency in the HC mode, i.e., in the frequency area FM in FIG. 7. In this embodiment, the resonance frequency in the HS mode and the resonance frequency in the HC mode are made close to each other at an appropriate frequency interval, as in the first embodiment.

In the state where the vibration in the HS mode and the vibration in the HC mode coexist, the amplitude displacements in the Z direction which are caused in the driving arms are in opposite directions. Thus, for example, when the left driving arm 2 attempts to be displaced in the +Z direction regarding a component in which the HS mode dominates the driving arm, a behavior in which the left driving arm 2 is displaced in the −Z direction regarding a component in which the HC mode dominates the driving arm is added thereto, so that the amplitude of the left driving arm 2 is reduced from an amplitude position P₂′, which would be reached with the HS mode only, to an amplitude position P₂, which is a returned position in the −Z direction. This applies also to the right driving arm 3. For example, when the right driving arm 3 attempts to be displaced in the −Z direction regarding a component in which the HS mode dominates the driving arm, a behavior in which the right driving arm 3 is displaced in the +Z direction regarding a component in which the HC mode dominates the driving arm is added thereto, so that the amplitude of the right driving arm 3 is reduced from an amplitude position P₃′, which would be reached with the HS mode only, to an amplitude position P₃, which is a returned position in the +Z direction. That is, when the HS mode and the HC mode coexist, the driving arms 2 and 3 take a vibration form in which vibrations cancel each other in the Z direction, resulting in a reduction of the amplitude of the driving arms.

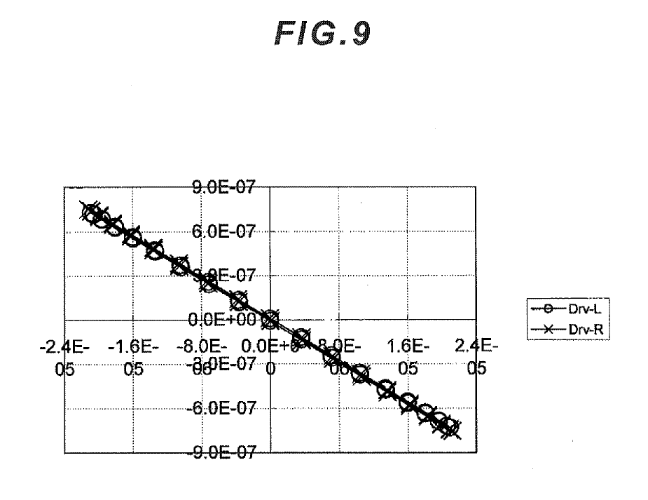

Next, FIGS. 9 to 11 show results of vibration analyses via a finite element method (FEM) regarding the behaviors of the driving arms 2 and 3 of the H type yaw rate sensor element 1 according to this embodiment. FIGS. 9 to 11 each are a plot concerning the left and right driving arms 2 and 3 (Drv-L and Drv-R) with the horizontal axis indicating displacement (amplitude) in the X direction (driving direction) of the driving arms 2 and 3 and the vertical axis indicating displacement (amplitude) in the Z direction (vibration detection direction). Note that the analyses have been performed such that the structures of the left and right driving arms comprise asymmetry so that displacement in the Z direction occurs, i.e., leakage vibration occurs even during non-rotation.

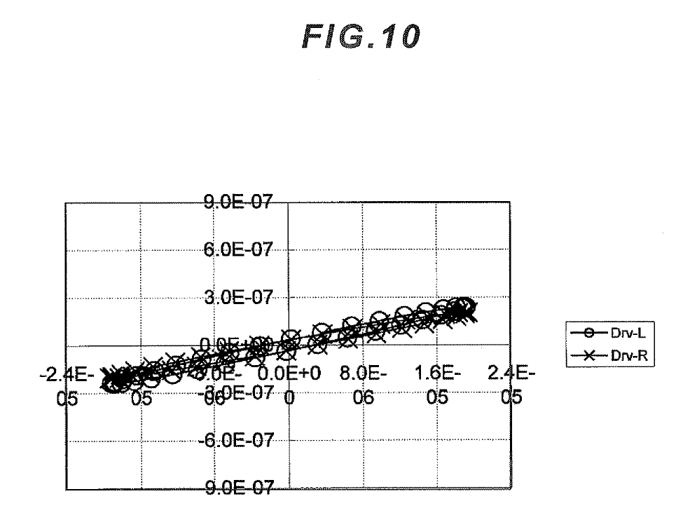

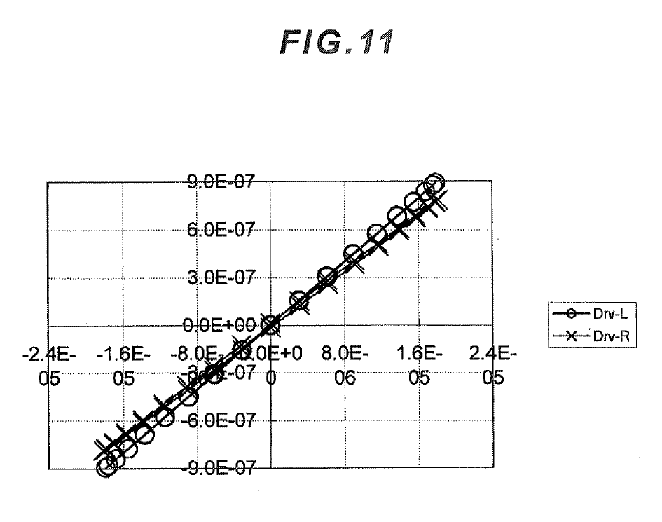

FIG. 9 shows the result of the case where the driving frequency exists in the FU area (the case where, in the order of frequency from lowest, the HS mode, the HC mode and the driving frequency higher by, e.g., about 3% than the HC mode are provided). FIG. 10 shows the result of the case where the driving frequency exists in the FM area (the case where, in the order of frequency from lowest, the HS mode, the driving frequency and the HC mode are provided). FIG. 11 shows the result of the case where the driving frequency exists in the FL area (the case where, in the order of frequency from lowest, the driving frequency lower by, e.g., about 3% than the HS mode, the HS mode and the HC mode are provided).

Comparing FIGS. 9 to 11 shows that, especially in the case where the driving frequency exists in the FM area in FIG. 10, the displacement, i.e., amplitude in the Z direction (vibration detection direction) has been reduced significantly to about ⅓^{rd} of that of each of the cases of FIGS. 9 and 11. This has confirmed that setting the driving frequency between the HS mode and the HC mode enables undesired noise, which is so called leakage vibration, in the driving arms to significantly be prevented from vibrating the detection arms in the state of non-rotation from the outside; that is, this has confirmed a noise removal effect in the H type yaw rate sensor element 1.

Further, as described in detail in the first embodiment, when making the resonance frequencies of the HS mode and the HC mode close to each other, the amplitudes of the detection arms 4 and 5 are expected to amplify each other to improve sensitivity with respect to a Coriolis force. Therefore, in this embodiment, in addition to the increase of the sensitivity improving effect in the first embodiment, the noise removal effect is provided to the H type yaw rate sensor element 1 by driving the sensor at a frequency between the resonance frequencies of the two vibration modes. The above effects are combined, whereby the S/N ratio of the H type yaw rate sensor element 1 can be improved dramatically.

Further, the H type yaw rate sensor element 1 according to this embodiment is sensitive to vibration since the HS mode and the HC mode coexist in the state where the behaviors in the modes are in balance in the driving arms 2 and 3. The balanced state is lost momentarily when a Coriolis force is generated due to the rotation of the sensor unit, and this may cause vibration due to a large impelling force. As a result, this expects a further improvement of sensitivity, and combined with the above-mentioned reduction of noise, can attain a high performance yaw rate sensor having a high S/N ratio,

It is considered that, when the driving frequency is the frequency fₓ, at which the detection sensitivity spectrum of the HS mode and the detection sensitivity spectrum of the HC mode cross each other in FIG. 6, the maximum noise removal effect of the driving arms due to the combination of the amplitudes in the two modes is obtained, and also the behaviors in the HS mode and the HC mode are in the most balanced state. Here, the maximum performance of the H type yaw rate sensor element 1 according to this embodiment can be kept. Further, as apparent from FIG. 6, when the frequency fₓ is selected as the driving frequency, the sensitivity changes gently in the total detection sensitivity spectrum, and is shifted to a high level instead of being reduced even if the resonance frequency of the driving arms varies to some extent because of a concern about assembly accuracy and precision. Accordingly, the driving frequency is set between the HS mode and the HC mode as in this embodiment, whereby an inter-individual variation in performance can be suppressed in the manufacturing of H type yaw rate sensors.

Note that the interval between the resonance frequencies in this embodiment can be set to a desired value by adjusting the interval between the arms if, for example, sensitivity stability with respect to a variation in thickness is desired.

### Third Embodiment

This embodiment shows the design guidelines of the H type yaw rate sensor element 1 shown in the first and second embodiments.

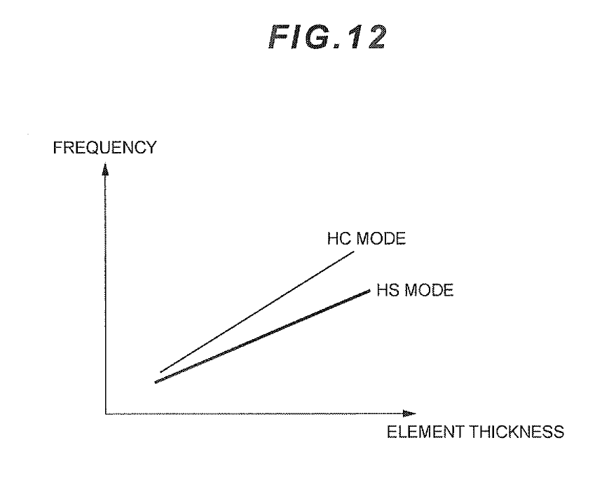

In the H type yaw rate sensors shown in the first and second embodiments, the motion of the detection arms produces vibration in the Z direction (thickness direction of the vibrator) in either the HS mode or the HC mode, and thus the resonance frequency of the detection arms in each of the modes can be set by adjusting the thickness of the H type yaw rate sensor element. FIG. 12 shows an example of the ratio of the resonance-frequency change (vertical axis) with respect to the thickness (horizontal axis) of the H type yaw rate sensor element in each of the HS mode and the HC mode. As shown here, the rate of change of the resonance frequency with respect to the thickness of the element differs between the HS mode and the HC mode. Therefore, taking into consideration the difference of the change, a desired combination of the resonance frequencies of the HS mode and the HC mode can be defined.

The rate of change of the resonance frequency of the detection arms with respect to the thickness of the element in FIG. 12 varies also depending on parameters that include the design such as width and length of each vibration arm, the arrangement interval between the vibration arms, the shapes of the cutouts in the base member to which the vibration arms are connected, the material of the element itself, etc. Accordingly, a desired combination of the resonance frequencies of the HS mode and the HC mode for the detection arms can also be defined by combining the above additional parameters with the thickness of the element.

Meanwhile, the driving vibration resonance frequency of the driving arms can be set by adjusting the width of each of the driving arms in the H type yaw rate sensor element since the driving direction of the driving arms produces vibration in the X direction (width direction of the vibrator). For example, when the width of the driving arm is increased, this regulates vibration drive in the X direction (width direction) of the driving arm, and thus the driving resonance frequency shows a tendency to be higher.

The rate of change of the resonance frequency of the driving arms with respect to the width of the element varies also depending on parameters that include the thickness of the element, the design such as length of each vibration arm, the arrangement interval between the vibration arms, the shapes of the cutouts in the base member to which the vibration arms are connected, the material, thickness, width, length, etc., of the element including an arm fixing part, etc. Accordingly, the resonance frequency of the driving arms can be set to a desired value by combining the above additional parameters with the width of the element.

The shape of each of the vibration arms in the above embodiments is constituted by a uniform width and thickness. However, a desired combination of resonance frequencies can also be defined by, for example, making only a tip end of the vibration arm have a wide width or changing a part of the thickness in the length direction of the vibration arm. Moreover, a desired combination of resonance frequencies can be defined by making the shape of the vibration arm asymmetric or changing the shape in the thickness direction (making the cross section have a trapezoidal shape or parallelogram shape). Fine-tuning the above additional parameters enables stable manufacturing of yaw rate sensors.

The present invention is not limited to the above embodiments, and can be modified in various ways (for example, appropriate combinations of the matters in the embodiments) without departing from the gist of the invention, as appropriately described above.

1, 100: yaw rate sensor (piezoelectric vibration device), 2, 3, 102, 103: driving arm, 4, 5, 104, 105: detection arm, 7, 107: center axis, 10, 110: base member, 15: frame, 16: connection island part, 17, 18: bridge part, 19, 20: auxiliary bridge part, 21, 22, 23, 24: cutout, f, F: frequency, P: amplitude position, S: sensitivity

1. A piezoelectric vibration type yaw rate sensor comprising:
at least one pair of driving arms and at least one pair of detection arms, the at least one pair of detection arms detecting a Coriolis force generated in the at least one pair of driving arms,
wherein a detection sensitivity spectrum of the at least one pair of detection arms has a first peak with, as a peak frequency, a first resonance frequency in a first detection vibration mode, in which the at least one pair of driving arms and the at least one pair of detection arms vibrate in opposite phases, and a second peak with, as a peak frequency, a second resonance frequency in a second detection vibration mode, in which the at least one pair of driving arms and the at least one pair of detection arms vibrate in the same phase, and
wherein, in the detection sensitivity spectrum, a detection sensitivity at a frequency higher by Δf than one smaller resonance frequency of the first resonance frequency and the second resonance frequency is larger than a detection sensitivity at a frequency lower by Δf than the one resonance frequency, and a detection sensitivity at a frequency lower by Δf than other larger resonance frequency of the first resonance frequency and the second resonance frequency is larger than a detection sensitivity at a frequency higher by Δf than the other resonance frequency.

2. The piezoelectric vibration type yaw rate sensor according to claim 1, wherein the detection sensitivity spectrum is a total of a detection sensitivity spectrum in the first detection vibration mode and a detection sensitivity spectrum in the second detection vibration mode.

3. The piezoelectric vibration type yaw rate sensor according to claim 1, wherein a driving vibration resonance frequency of the driving arms is set between the first resonance frequency in the first detection vibration mode and the second resonance frequency in the second detection vibration mode.

4. The piezoelectric vibration type yaw rate sensor according to claim 1, comprising a base member that includes:
a frame to which the at least one pair of driving arms and the at least one pair of detection arms are connected;
a connection island part that is formed inside the frame;
a plurality of bridge parts that extends in a direction parallel to an extending direction of the at least one pair of driving arms and/or the at least one pair of detection arms and is provided across the frame; and
a plurality of auxiliary bridge parts that connects the connection island part and the plurality of bridge parts.

5. A method of detecting an angular velocity of a piezoelectric vibration type yaw rate sensor by detecting, by at least one pair of detection arms in the piezoelectric vibration type yaw rate sensor, a Coriolis force generated in at least one pair of driving arms in the piezoelectric vibration type yaw rate sensor, the method comprising:
configuring or controlling the piezoelectric vibration type yaw rate sensor such that a detection sensitivity spectrum of the at least one pair of detection arms has a first peak with, as a peak frequency, a first resonance frequency in a first detection vibration mode, in which the at least one pair of driving arms and the at least one pair of detection arms vibrate in opposite phases, and a second peak with, as a peak frequency, a second resonance frequency in a second detection vibration mode, in which the at least one pair of driving arms and the at least one pair of detection arms vibrate in the same phase, and such that in the detection sensitivity spectrum, a detection sensitivity at a frequency higher by Δf than one smaller resonance frequency of the first resonance frequency and the second resonance frequency is larger than a detection sensitivity at a frequency lower by Δf than the one resonance frequency, and a detection sensitivity at a frequency lower by Δf than other larger resonance frequency of the first resonance frequency and the second resonance frequency is larger than a detection sensitivity at a frequency higher by Δf than the other resonance frequency.

6. The angular velocity detection method according to claim 5, wherein a driving vibration resonance frequency of the driving arms is set between the first resonance frequency in the first detection vibration mode and the second resonance frequency in the second detection vibration mode.

7. The piezoelectric vibration type yaw rate sensor according to claim 2, wherein a driving vibration resonance frequency of the driving arms is set between the first resonance frequency in the first detection vibration mode and the second resonance frequency in the second detection vibration mode.

8. The piezoelectric vibration type yaw rate sensor according to claim 2, comprising a base member that includes:
a frame to which the at least one pair of driving arms and the at least one pair of detection arms are connected;
a connection island part that is formed inside the frame;
a plurality of bridge parts that extends in a direction parallel to an extending direction of the at least one pair of driving arms and/or the at least one pair of detection arms and is provided across the frame; and
a plurality of auxiliary bridge parts that connects the connection island part and the plurality of bridge parts.

9. The piezoelectric vibration type yaw rate sensor according to claim 3, comprising a base member that includes:
a frame to which the at least one pair of driving arms and the at least one pair of detection arms are connected;
a connection island part that is formed inside the frame;
a plurality of bridge parts that extends in a direction parallel to an extending direction of the at least one pair of driving arms and/or the at least one pair of detection arms and is provided across the frame; and
a plurality of auxiliary bridge parts that connects the connection island part and the plurality of bridge parts.

10. The piezoelectric vibration type yaw rate sensor according to claim 7, comprising a base member that includes:
a frame to which the at least one pair of driving arms and the at least one pair of detection arms are connected;
a connection island part that is formed inside the frame;
a plurality of bridge parts that extends in a direction parallel to an extending direction of the at least one pair of driving arms and/or the at least one pair of detection arms and is provided across the frame; and
a plurality of auxiliary bridge parts that connects the connection island part and the plurality of bridge parts.
